(19) United States
(12) Patent Application Publication
(10) Pub. No.: US 2025/0384213 A1
(43) Pub. Date: Dec. 18, 2025

(54) SYSTEM AND METHOD FOR EMOTIONAL TEXT ANALYSIS AND MARKUP

(71) Applicants: Constructor Technology AG, Schaffhausen (CH); Constructor Education and Research Genossenschaft, Schaffhausen (CH)

(72) Inventors: Stiven Kulla, Saluzzo (IT); Sergey Aksenov, Belgrade (RS); Serg Bell, Costa del Sol (SG); Stanislav Protasov, Singapore (SG); Laurent Dedenis, Singapore (SG); Nikolay Dobrovolskiy, Istambul (TR)

(21) Appl. No.: 18/744,154

(22) Filed: Jun. 14, 2024

(51) Int. Cl. G06F 40/30; G06F 40/205; G06T 13/40; G10L 13/08

(52) U.S. Cl. CPC G06F 40/30; G06F 40/205; G06T 13/40; G10L 13/08

(57) ABSTRACT

Systems and methods for automated emotional text analysis and markup utilizing a sliding window mechanism. A method includes receiving input text data and employing a text preprocessing unit to parse the data into text segments. A contextual window control unit within a text markup unit applies a sliding window mechanism to each text segment, creating context windows for sentiment analysis. An emotional analysis model within the sentiment classification unit classifies the sentiment of the text segments within context windows. The emotional text markup unit associates classification results with the respective text segments, generating marked-up text that is used to produce media content with emotional expressions.

### TECHNICAL FIELD

Embodiments relate generally to the field of automated sentiment and emotion recognition in textual data. More particularly, embodiments relate to systems and methods for applying a sliding window mechanism for sentiment analysis and markup in text, used in creating emotionally responsive digital avatars.

### BACKGROUND

In the realm of digital avatar generation, a significant challenge lies in the integration of emotional nuances. Current techniques typically involve the independent processing of text and emotional tags, leading to a disjointed and often unnatural portrayal of emotions in avatars. Customarily, authors or creators of avatar animations enhance the realism of these avatars by manually setting emotional parameters. These parameters, often implemented as tags, are assigned to specific timestamps, sentences, or words within the text. While this method can achieve moments of realistic expression, it generally results in a media output that feels unevenly emotional or mechanically articulated.

One notable problem is the lack of natural fluidity in the avatar's emotional expressions. At certain points where the tags are accurately defined, the avatar might exhibit a high degree of realism. However, in the absence of these tags or in instances of inaccurate tagging, the avatar's expressions can become notably artificial, disrupting the overall experience of realism. This inconsistency is particularly evident in dynamically changing scenarios or complex dialogues where emotional transitions are frequent and subtle.

Moreover, the emotional structure and conveyance vary significantly across different languages and fields. For instance, what constitutes a display of excitement in one language might be vastly different in another. Similarly, the emotional tone expected in a business presentation differs markedly from that in a fictional narrative. Such variations necessitate a highly adaptable approach to emotional tagging, one that can accurately reflect the diverse emotional landscapes of different languages and contexts.

Currently, the process of configuring avatars to reflect these varied emotional nuances is exceedingly intricate. It demands a high level of manual input and fine-tuning, which can be both time-consuming and technically challenging. This complexity often acts as a barrier, especially for creators who may lack the expertise or resources to manually tag and adjust emotional parameters effectively.

Therefore, there is a need for a sophisticated, automated text tagging solution that intuitively understands and marks emotional cues within the text, thereby enabling the generation of voice and animation that is both realistic and emotionally balanced.

### SUMMARY

Embodiments described or otherwise contemplated herein substantially meet the aforementioned needs of the industry. Systems and methods provide automated emotional text analysis and markup utilizing a sliding window mechanism. In one aspect, a method includes receiving input text data and employing a text preprocessing unit to parse the data into text segments. A contextual window control unit within a text markup unit applies a sliding window mechanism to each text segment, creating context windows for sentiment analysis. An emotional analysis model within the sentiment classification unit classifies the sentiment of the text segments within context windows. The emotional text markup unit associates classification results with the respective text segments, generating marked-up text that is used to produce media content with emotional expressions.

In an embodiment, a method for automated emotional text analysis and markup comprises receiving input text data; preprocessing said input text data to identify and extract text segments; applying a sliding window mechanism to each text segment to create a context window for sentiment analysis; classifying the sentiment of the text within the context window using an emotional analysis model, wherein the result of the classification is a verdict containing at least one sentiment class with an accuracy value, wherein the accuracy value characterizes the confidence level of the classification by indicating the probabilistic likelihood of he text segment and the sentiment class; extending the window size for the text segment to create an extended window if the classification accuracy is below a predefined threshold and classifying the sentiment of the text segment within the extended window; associating the classification verdict with the respective text segments to generate sentiment-classified text segments; and generating media content based on the sentiment-classified text segments.

In an embodiment, a system for automated emotional text analysis and markup, comprises at least one processor and memory operably coupled to the at least one processor; instructions that, when executed, cause the at least one processor to implement: a text preprocessing unit configured to receive input text data and parse said data into text segments; a text markup unit configured to apply contextual analysis to the text segments, the text markup unit comprising: a contextual window control unit configured to define context windows for sentiment analysis on the text segments, a sentiment classification unit configured to classify the sentiment of the text within the context windows, and an emotional text markup unit configured to annotate the text segments with emotional tags based on the sentiment classification; and an avatar generation unit configured to generate media content based on the sentiment-classified and emotionally annotated text segments.

The above summary is not intended to describe each illustrated embodiment or every implementation of the subject matter hereof. The figures and the detailed description that follow more particularly exemplify various embodiments.

### BRIEF DESCRIPTION OF THE DRAWINGS

Subject matter hereof may be more completely understood in consideration of the following detailed description of various embodiments in connection with the accompanying figures, in which:

FIG. 1 is a functional schema of a system for emotional text analysis and markup, in accordance with an embodiment.

FIG. 2 is a text processing flow diagram, in accordance with an embodiment.

FIG. 3 is a block diagram of a sliding window mechanism, in accordance with an embodiment.

FIG. 4 is a flowchart diagram of a method for emotional text analysis and markup, in accordance with an embodiment.

While various embodiments are amenable to various modifications and alternative forms, specifics thereof have been shown by way of example in the drawings and will be described in detail. It should be understood, however, that the intention is not to limit the claimed inventions to the particular embodiments described. On the contrary, the intention is to cover all modifications, equivalents, and alternatives falling within the spirit and scope of the subject matter as defined by the claims.

### DETAILED DESCRIPTION

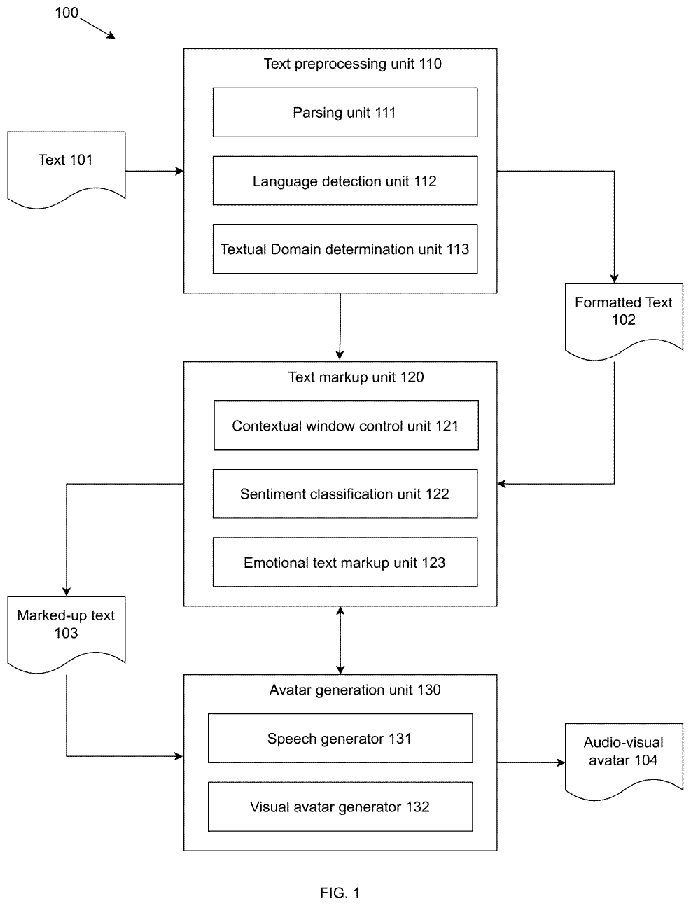

FIG. 1 depicts a functional schema of a system 100 for emotional text analysis and markup which is utilized for generating emotionally expressive digital avatars. In an embodiment, system 100 generally comprises at least one processor having an operably coupled memory, and instructions that, when executed, cause the at least one processor to implement a text preprocessing unit 110, a text markup unit 120, and an avatar generation unit 130. The functional interconnectivity of system components ensures the seamless transformation of the initial textual input into an expressive avatar. The primary measures of efficiency and effectiveness of the system include the speed of avatar generation and the high accuracy of emotional representation. High values of measures are achieved through a highly integrated system architecture where all units operate using a single, standardized text format. By using common structured data formats, including a text format, the text preprocessing unit 110, text markup unit 120, avatar generation unit 130 and corresponding sub-components can directly access and process the data without the need for additional reformatting or synchronization efforts.

Source text 101 undergoes preprocessing to convert source text 101 in standard format from any type and formatting styles. The transition from formatted text 102 to marked-up text 103 involves the assignment of emotion-specific tags, which are then interpreted by avatar generation unit 130 to produce a responsive and emotionally expressive avatar, synchronized in both speech and visual demeanor. The system thereby provides an end-to-end solution for creating avatars that can engage users with a human-like emotional presence.

Source text 101 is typically narrative content, such as dialogue from a story or transcript of a speech, which serves as the verbal script for the avatar. The necessity for text preprocessing stems from the need to standardize various forms of written language into a consistent format for emotional analysis.

Text preprocessing unit 110 processes source text 101, which may contain diverse linguistic elements that require normalization for subsequent analysis. Text preprocessing unit 110 solves problems associated with language variability by employing a parsing unit 111 that can, for example, standardize idiomatic expressions and correct textual anomalies to ensure uniformity in the analysis. The parsing by parsing unit 111 is further described herein.

Formatted text 102 is the standardized output of text preprocessing unit 110 and serves as a refined input for emotional markup. It is essential that formatted text 102 maintains the narrative's integrity while being optimized for emotion detection algorithms.

Text markup unit 120 receives formatted text 102 and annotates it with emotional metadata. Text markup unit 120 utilizes natural language processing algorithms to assign emotional states to segments of the text, preparing the text for expressive avatar rendering. Marked-up text 103 is the emotionally annotated version of the source text 101, containing indicators that guide the visual and auditory representation of the digital avatar's emotions.

Avatar generation unit 130 utilizes marked-up text 103 to construct the audio-visual avatar output 104. Speech generator 131 within avatar generation unit 130 can implement a text-to-speech engine designed to modulate vocal intonation in line with the emotional annotations. Visual avatar generator 132 can use animation algorithms to translate the emotional tags from marked-up text 103 into corresponding facial expressions and body language of the digital avatar. The audio-visual avatar is configured to visualize a range of movements, referred to as avatar movements, that enhance the emotional expressiveness and interactivity of the digital avatar on the screen. The avatar movement includes body movements and facial expressions, which are dynamically generated based on the emotional analysis of the text. These movements include gestures, postures, and other physical actions that convey emotions such as happiness, sadness, anger, or surprise, enhancing the realism of the avatar. Facial expressions include movements of the eyebrows, eyes, mouth, and other facial muscles. In one embodiment, avatar movements include cinematic techniques, such as zooming in and zooming out, varying the angle of view. For example, a zoom-in on the avatar face during a moment of introspection or a critical announcement can draw the viewer attention to the detailed facial expressions, heightening the impact of the avatar's emotional delivery. The avatar can perform other screen movements such as shifting from one side to the other, leaning forward or backward, and other subtle movements.

Source text 101 represents information data that may be provided in various formats, including but not limited to text files, documents, web-pages, or other forms of data containing textual information. System 100 is configured to accept source text 101 in different file types, such as digital text files (.txt), word processing documents (.docx, .odt), portable document formats (.pdf), and content from web pages (HTML, XML). Source text 101 can originate from content written in multiple languages. Text preprocessing unit 110 is equipped with language detection unit 112, which is configured for identifying and processing the language of source text 101, enabling the system to manage and interpret textual content from a broad linguistic spectrum. In an embodiment, text language detection unit 112 utilizes a combination of statistical methods and machine learning models to accurately determine the language of the input text. For example, language detection unit 112 performs n-gram analysis, where the frequency and arrangement of contiguous sequences of characters or words are analyzed to predict the language. In another embodiment, the language detection unit 112 can incorporate machine learning classifiers that have been trained on datasets of multilingual text, enhancing its ability to distinguish between closely related languages or dialects. Once the language is identified, language detection unit 112 can adjust the subsequent text processing steps, such as tokenization and parsing, to align with the specific grammatical and syntactical rules of the identified language, thereby optimizing the accuracy of the emotional analysis performed by subsequent system units.

Additionally, source text 101 may include content from various topics, such as journalistic articles, scientific papers, fictional narratives, or conversational dialogues. A textual domain determination unit 113 within text preprocessing unit 110 is configured to determine the contextual domain of source text 101, facilitating the system's ability to handle content with different thematic and emotional ranges. In an embodiment, the domain determination unit 113 utilizes topic modeling algorithms, such as Latent Dirichlet Allocation (LDA) to analyze word distributions and discern underlying themes, and integrates named entity recognition to categorize key entities, enhancing thematic context recognition. Additionally, machine learning classifiers trained on diverse domain-specific datasets refine the precision of domain identification.

Moreover, source text 101 may embody diverse writing styles, ranging from the highly formal tone of academic papers to the informal and idiomatic expressions found in personal blogs or dialogues. Text preprocessing unit 110 analyzes and processes these stylistic variations, ensuring that the emotional markup applied by text markup unit 120 accurately reflects the intended expressions and subtleties of the original text. In an embodiment, text preprocessing unit 110 utilizes natural language processing techniques to detect and adapt to different writing styles. Through the implementation of syntax analysis and contextual parsing, the text preprocessing unit 110 identifies unique stylistic features. The system architecture, therefore, supports a comprehensive approach to preparing source text 101, regardless of its format, language, topic, or style, for the subsequent stages of emotional analysis and avatar generation.

Parsing unit 111 within text preprocessing unit 110 is configured to dissect source text 101 into its constituent elements. In one embodiment, parsing unit 111 can utilize syntactic parsing techniques to decompose the text into sentences, phrases, and words. Parsing unit 111 can employ tokenization algorithms to separate punctuation from words, part-of-speech tagging to classify words into their respective grammatical categories, and dependency parsing to establish relationships between words, enabling a structural understanding of the text.

Language detection unit 112 is configured to identify the language in which source text 101 is written. In one embodiment, language detection unit 112 can implement a statistical approach, utilizing n-gram models to predict the language based on the frequency and arrangement of character sequences within the text. Alternatively, language detection unit 112 can use machine learning classifiers trained on a large set of multilingual texts to distinguish between languages with high accuracy.

Textual domain determination unit 113 ascertains the contextual domain of source text 101. In one embodiment, textual domain determination unit 113 can apply topic modeling algorithms like Latent Dirichlet Allocation (LDA) to identify underlying topics within the text. Textual domain determination unit 113 can also utilize named entity recognition (NER) to extract and categorize key entities such as people, organizations, and locations, providing insights into the text's domain. In another embodiment, textual domain determination unit 113 can employ machine learning techniques, using training datasets labeled with domain-specific markers to classify the text into categories such as news, fiction, technical, or conversational.

In an embodiment, parsing unit 111, language detection unit 112, and textual domain determination unit 113 collectively prepare the source text 101 for emotional analysis, ensuring that the system recognizes the linguistic structure, language, and domain context accurately. This preprocessing stage is essential for the successful application of emotional tags in subsequent units. The determined language and textual domain, along with optional metadata derived during the parsing process, are transferred to text markup unit 120. This information facilitates adaptive operation within text markup unit 120, allowing for tailored emotional analysis and markup that aligns with the specific linguistic and contextual nuances of source text 101. The adaptability of text markup unit 120 ensures that the emotional tagging is sensitive to the language and domain-specific characteristics identified, enhancing the accuracy and relevance of the emotional annotations applied to the text.

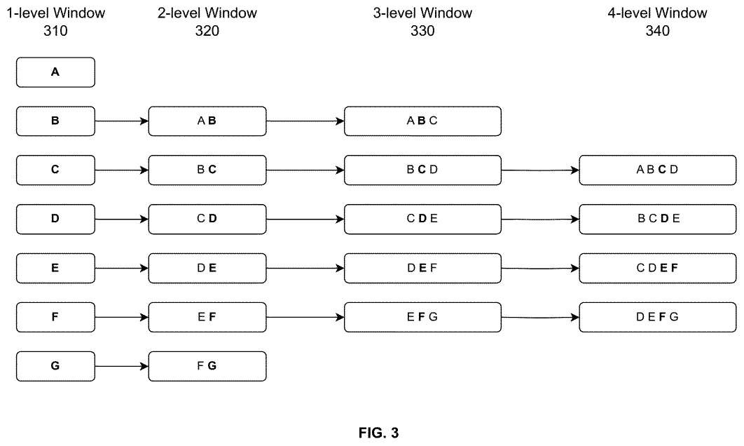

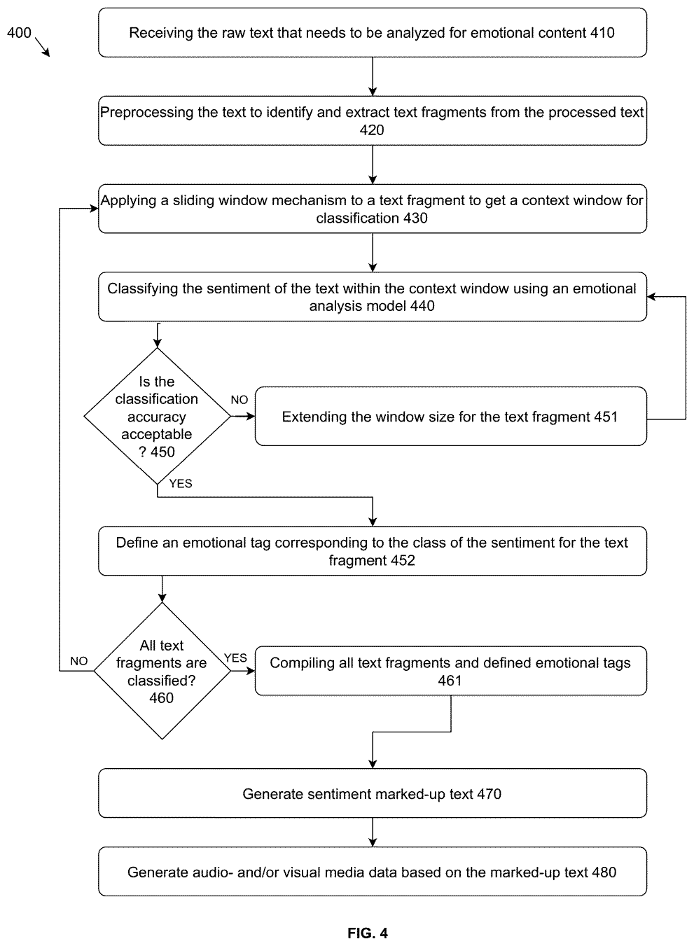

Contextual window control unit 121 within text markup unit 120 operates to define the scope of context for emotional analysis of formatted text 102. In one embodiment, contextual window control unit 121 can implement sliding window algorithms that capture a defined range of words or sentences surrounding a target word, ensuring that emotional classification considers relevant surrounding text. Contextual window control unit 121 can also dynamically adjust the size of the contextual window based on linguistic cues or the density of emotional content, optimizing the precision of sentiment analysis. The contextual window adjustment includes analyzing the text for key emotional words, idiomatic expressions, and complex syntactic structures. If the text segment contains ambiguous phrases or dense emotional expressions that require broader context for clarity, the contextual window control unit 121 expands the window to include more surrounding text. If intense emotional content is localized within a specific segment, the contextual window control unit 121 narrows the focus to enhance sentiment accuracy. Linguistic cues include the presence of specific keywords, phrase structures, that signify underlying sentiments or the need for broader context to capture nuanced meanings. For example, if a phrase includes modal verbs or conditional clauses that could alter the sentiment interpretation based on the surrounding text, the contextual window control unit 121 will expand the contextual window to ensure that these conditional sentiments are correctly understood in their wider linguistic context. Additionally, if the text segment contains transitional phrases such as “however” or “on the other hand,” which often indicate a shift in tone or sentiment, the contextual window control unit 121 can also adjust the window size to encompass these shifts fully. Window control is further discussed further with respect to FIGS. 3 and 4.

Sentiment classification unit 122 is configured to categorize segments of formatted text 102 into emotional states. In one embodiment, sentiment classification unit 122 can leverage sentiment analysis models that use machine learning to infer emotions from text, such as support vector machines (SVM), deep neural networks or recurrent neural networks. These models may be trained on annotated datasets where text segments are labeled with emotional states. In another embodiment, sentiment classification unit 122 can utilize lexicon-based approaches that reference databases of words associated with specific emotions, scoring text segments based on the presence and combination of these words. In an embodiment, because sentiment analysis models are quite fast, a plurality of sentiment analysis models can be run parallel. Subsequent, the one model can be selected based on evaluation of the results of the plurality of sentiment analysis models against a quality criteria.

In one embodiment, sentiment classification unit 122 receives portions of formatted text 102 that have been delineated by the contextual window control unit 121. Contextual window control unit 121 utilizes a sliding window technique to determine the relevant text for analysis, ensuring that the sentiment classification unit 122 considers the appropriate linguistic context surrounding specific phrases or expressions.

The sliding window approach allows sentiment classification unit 122 to focus on coherent blocks of text, such as a sentence or a paragraph, that are likely to contain a consistent emotional tone. By analyzing text within these defined windows, sentiment classification unit 122 can more accurately discern the sentiment being conveyed, whether it be joy, sadness, sarcasm, or any other emotion. For instance, sentiment classification unit 122 can apply natural language processing algorithms to evaluate the sentiment of a sentence within the window defined by contextual window control unit 121. If the sentence includes phrases like “overjoyed to hear” or “deeply saddened by,” sentiment classification unit 122 assigns emotional tags corresponding to happiness or sadness, respectively. These tags are then passed on to the emotional text markup unit 123 for annotation.

Emotional text markup unit 123 is responsible for annotating formatted text 102 with emotional tags based on the classifications provided by sentiment classification unit 122. In one embodiment, emotional text markup unit 123 can use markup languages like XML or JSON to add annotations directly into the text, specifying the type and intensity of the detected emotions. Alternatively, emotional text markup unit 123 can employ a tagging schema that links emotional tags to text segments without altering the original text, facilitating the retrieval of emotional data by avatar generation unit 130.

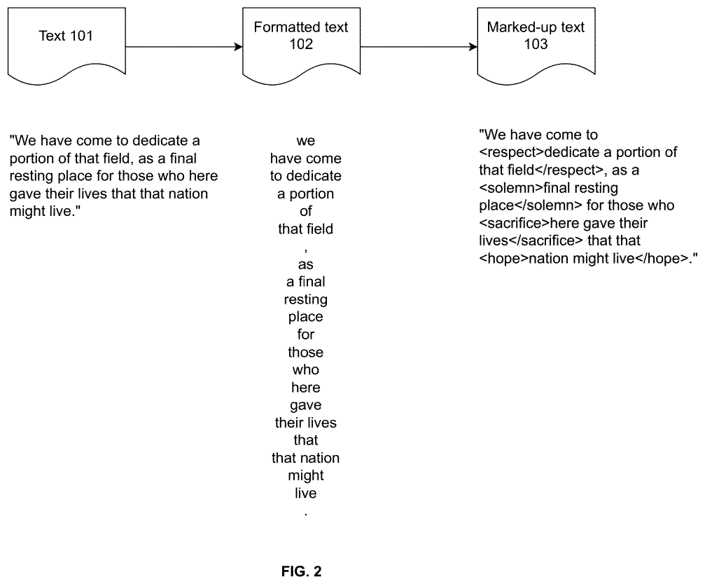

FIG. 2 depicts a text processing flow diagram within one embodiment of system 100 for emotional text analysis and markup. FIG. 2 illustrates the transformation from source text 101 through formatted text 102 to marked-up text 103.

Source text 101 is presented as a raw input excerpt, “We have come to dedicate a portion of that field, as a final resting place for those who here gave their lives that that nation might live.” This text is representative of a narrative that requires emotional tagging to convey the appropriate sentiment when rendered by a digital avatar.

Formatted text 102 shows the result of the text preprocessing unit processing of source text 101. The text is contextually unchanged but has been formatted and structured to remove any superfluous elements such as extra spaces or non-standard punctuation that may interfere with the subsequent markup process.

Marked-up text 103 is the output after formatted text 102 has been analyzed by text markup unit 120. Emotional annotations are embedded within the text, surrounding the phrases with tags that denote the intended sentiment. For example, the phrase “dedicate a portion of that field” is encapsulated by the tag “<respect></respect>”, signifying that this segment should be expressed with a tone of respect. Similarly, “a final resting place” is marked with “<solemn></solemn>”, indicating a solemn tone, and “gave their lives” with “<sacrifice></sacrifice>”, which suggests a tone of sacrifice. The final phrase, “that nation might live”, is surrounded by “<hope></hope>”, to be rendered with a hopeful tone.

Marked-up text 103 can be embodied in various formats and standards that support rich text annotations, such as HTML, XML, JSON, or other markup languages. In HTML, the emotional tags can be represented as custom data attributes or classes, allowing for the integration with web-based avatar platforms. XML offers a highly structured way to represent the emotional annotations, where each emotion can be defined as a separate tag, providing a clear hierarchy and relationship between the emotional states and the text.

In another embodiment, JSON can be used to encapsulate the emotional annotations along with the text, structuring the data as key-value pairs where the keys represent the emotional states and the values contain the corresponding text segments. This format is particularly suited for systems that may process the marked-up text programmatically, such as in applications where the avatar is rendered in real-time and the emotional states need to be rapidly parsed and applied.

Furthermore, the aforementioned markup formats allow for extensibility and compatibility with various systems, making it possible to integrate the marked-up text into a wide array of digital platforms and applications. The choice of format can be tailored to the specific requirements of the system in which the avatar is being used, whether it is for an interactive web service, a desktop application, or a mobile app, ensuring that the emotional annotations are preserved and interpreted consistently across different environments.

FIG. 3 depicts a block diagram of a sliding window mechanism used within the sentiment classification process of text analysis. FIG. 3 illustrates how text is parsed into discrete parts labeled A through G, which can represent words, sentences, phrases, or any segment of text. In an embodiment, the sliding window mechanism can be implemented by, for example, sentiment classification unit 122.
1-level Window 310 shows individual parts in isolation, indicating that each segment is considered independently without any contextual influence from adjacent parts. For instance, part C is analyzed solely within its own window.
2-level Window 320 illustrates windows that encompass a pair of consecutive parts. A main part is paired with a subsequent part to provide immediate contextual information. For example, window BC includes part B as the main part and part C as the subsequent part.
3-level Window 330 expands the context to include three parts: the main part, the preceding part, and the following part. In this way, part C (main part) is now considered within the context of part B (preceding part) and D (following part), providing a broader contextual scope for analysis.
4-level Window 340 further extends the context to incorporate four parts: the main part, the two parts preceding the main part, and the following part. This level offers an even more expansive view of the text, as demonstrated by the window BCDE, which includes parts B and C (two preceding), D (main part), and E (following part).

The purpose of these varying window levels is to iteratively analyze the text to determine the most appropriate emotional tag for each part and for the main part as a result. The process begins with the narrowest context at 1-level Window 310 and progresses through each increasing level of context 2-level Window 320, 3-level Window 330, and 4-level Window 340 until sentiment classification unit 122 determines the emotional class for the text segment. The number of levels and the size of each window can be adjusted based on the length of the text and the complexity of the emotional nuances present. For short texts, such as tweets or short messages, the number of levels is increased until the window size is set to encompass the entire text, allowing for a complete overview of the context in a single analysis. For medium-length texts like news articles or blog posts, the window spans several sentences. In the case of longer documents, such as lectures or research papers, the window size is increased to include entire paragraphs or sections. In an embodiment, the contextual window control unit 121 dynamically adjusts the size of the contextual window based on the length of the text to optimize the number of iterations and calculations required for accurate emotional tagging, without compromising quality. In one example, for short texts, the initial window size is set to one word, with each subsequent window incrementally expanding by one word. In another example, for medium-length texts, the initial window size starts at two words, with each following window increasing by two words, balancing thorough context capture and processing speed. In another example, in the case of longer texts, the window begins with three words, and each subsequent window expands by three words, allowing the system to quickly cover more extensive sections of the text while still capturing evolving sentiments effectively. Sentiment classification unit 122 iteratively analyzes the content within each window level, starting from the 1-level Window 310 and progressing through to the 2-level Window 320, 3-level Window 330, and 4-level Window 340 as necessary, until an emotional classification is determined for each segment. In one aspect, the contextual window control unit 121 expands the window and inference classification is conducted. If classification can be made, window size adjustment stops.

This sliding window mechanism allows for a granular as well as a holistic view of the text, facilitating a nuanced sentiment analysis that takes into account both the immediate and broader context surrounding each text segment. The result is a marked-up text where each segment is annotated with an emotional tag that reflects not just the segment's intrinsic sentiment but also the influence of surrounding text, leading to a more accurate and emotionally coherent output.

The sliding window approach addresses the challenge of classifying the emotional content of single text segments that may not convey a clear emotional tone in isolation. Text segments, when taken out of context, can lack the emotional clarity required for accurate classification. However, when these segments are viewed within the scope of surrounding words, their emotional valence can become more discernible.

For example, a single word may not carry a strong emotional indicator until it is considered in conjunction with its neighboring words. The 2-level Window 320, 3-level Window 330, and 4-level Window 340 provide increasing levels of context, which can reveal the emotional undertones implied by sequences of words. This context-rich analysis allows for a more reliable determination of the emotional state conveyed by the text.

Once the emotional tone of a window has been classified, the system can then retroactively assign an emotional tag to the main part of the text based on the emotional classification of the window in which it appears. For example, if the 3-level Window 330 containing parts B, C, and D is classified as expressing sadness, the main part C can be tagged with an emotional label indicating sadness, even if part C alone would not necessarily be classified that way. In one embodiment, processing can stop after a given level classification depending on the classification verdict.

FIG. 4 depicts a flowchart of a method 400 for emotional text analysis and markup. Method 400 starts at 410 with the receipt of raw text, which is to be analyzed for emotional content.

At 420, preprocessing of the text occurs to identify and extract text fragments, segmenting the raw text into parts more suitable for detailed emotional analysis. For example, text preprocessing unit 110 can receive text 101.

Proceeding to 430, a sliding window mechanism is applied to each text fragment. The size of the sliding window determines the amount of contextual information included for each fragment's emotional classification. For example, formatted text 102 can be passed to text markup unit 120. Contextual window control unit 121 can define the scope of context for emotional analysis of formatted text 102.

At 440, the sentiment of the text within the context window is classified. An emotional analysis model processes the text fragment within the given window, assigning an emotional category to the fragment; for example, emotional text markup unit 123.

Decision block 450 assesses the classification accuracy. If the accuracy is insufficient, block 451 is engaged, which involves extending the window size for the text fragment, providing a broader context to achieve a more accurate classification. The assessment of the classification accuracy can be performed by contextual window control unit 121.

Upon obtaining an acceptable classification, comparing the classification verdict accuracy with predetermined accuracy threshold, block 452 defines an emotional tag that corresponds with the sentiment classification of the text fragment. In one embodiment, the resulting tag is assigned to the initial text segment of the 1-level window. Classifying the sentiment of the text within the context window is executed using the sentiment analysis model. The sentiment analysis model generates a classification outcome, referred to as a verdict, which includes one or more sentiment classes assigned to the text segment. Each sentiment class in the verdict is accompanied by an accuracy value, a critical measure that characterizes the confidence level of the classification. The accuracy value is a probabilistic value that quantifies the likelihood that the analyzed text segment correctly corresponds to the assigned sentiment class. This value is expressed as a percentage, where a higher percentage represents a higher probability that the sentiment classification is accurate, reflecting the model's confidence in the classification. The probabilistic nature of this value allows for a nuanced understanding of how well the sentiment identified by the model matches the emotional tone conveyed in the text segment, providing a quantifiable measure to assess the reliability of the sentiment analysis

Method 400 reaches a decision point at block 460, where a check if all text fragments have been classified is conducted. If unclassified fragments remain, method 400 loops back to continue the classification process.

After all text fragments are classified and tagged, all fragments and their corresponding emotional tags are compiled into a unified structure of marked-up text 103.

At 470, a sentiment marked-up text is generated, integrating the emotional tags with their respective text fragments to form a fully annotated script.

Method 400 proceeds with audio and visual media data generation based on the sentiment marked-up text at 480. The output is an emotionally expressive rendition of the original text, ready for utilization in digital avatars that require synchronized vocal and facial expressions to convey the designated emotions.

1. A method for automated emotional text analysis and markup, comprising:
receiving input text data;
preprocessing said input text data to identify and extract text segments;
applying a sliding window mechanism to each text segment to create a context window for sentiment analysis;
classifying a sentiment of the text within the context window using an emotional analysis machine-learning model, wherein an input of the emotional analysis machine-learning model is a context window and a result of the classification is a verdict containing at least one sentiment class with an accuracy value, wherein the accuracy value characterizes the confidence level of the classification by indicating the probabilistic likelihood of the text segment and the sentiment class;
extending the window size for the text segment to create an extended window if the classification accuracy is below a predefined threshold and classifying the sentiment of the text segment within the extended window;
associating the classification verdict with the respective text segments to generate sentiment-classified text segments; and
generating media content based on the sentiment-classified text segments.

2. The method of claim 1, further comprising:
determining a language of the input text data; and
applying the sliding window mechanism for each text segment based on the language.

3. The method of claim 2, wherein the emotional analysis model is selected based on the language of the input text data.

4. The method of claim 1, further comprising:
determining a textual domain of the input text data; and
applying the sliding window mechanism for each text segment based on the textual domain.

5. The method of claim 4, wherein the emotional analysis model is selected based on the textual domain of the input text data.

6. The method of claim 1, wherein the output of the sentiment classification is used as an input for a speech generator to create audio content that reflects the tagged emotional states.

7. The method of claim 1, wherein the output of the sentiment classification is used as an input for generating digital avatar movement.

8. The method of claim 1, wherein the text segment is a word, a phrase, or a sentence.

9. The method of claim 1, wherein the sentiment analysis model is a support vector machine, a deep neural network, or a recurrent neural network.

10. The method of claim 1, further comprising compiling all sentiment-classified text segments and associated emotional tags to form a marked-up text for generation of media content.

11. A system for automated emotional text analysis and markup, comprising:
at least one processor and memory operably coupled to the at least one processor;
instructions that, when executed, cause the at least one processor to implement:
a text preprocessing unit configured to receive input text data and parse said data into text segments;
a text markup unit configured to apply contextual analysis to the text segments, the text markup unit comprising:
a contextual window control unit configured to define context windows for sentiment analysis on the text segments,
a sentiment classification unit configured to classify a sentiment of the text within the context windows, and
an emotional text markup unit configured to annotate the text segments with emotional tags based on the sentiment classification; and
an avatar generation unit configured to generate media content based on the sentiment-classified and emotionally annotated text segments.

12. The system of claim 11, wherein the sentiment classification unit further comprises an emotional analysis machine learning model for classifying text segments.

13. The system of claim 12, wherein the text preprocessing unit is further configured to determine a language of the input text data, wherein the emotional analysis machine learning model is particularly trained for the language.

14. The system of claim 11, wherein the text preprocessing unit is further configured to identify a textual domain of the input text data, wherein the emotional analysis machine learning model is particularly trained for the textual domain.

15. The system of claim 11, wherein the emotional analysis model is at least one of a support vector machine (SVM), recurrent neural network (RNN), or deep neural network.

16. The system of claim 11, wherein the emotional text markup unit is further configured to compile all sentiment-classified text segments and associated emotional tags to form a marked-up text for the media generation.

17. The system of claim 16, wherein the avatar generation unit includes a speech generator configured to produce speech audio from the marked-up text.

18. The system of claim 11, wherein the avatar generation unit includes a visual avatar generator configured to animate the digital avatar with facial expressions and body movements based on marked-up text.

19. The system of claim 11, wherein the text markup unit is further configured to reprocess the text segments with extended context window, when initial sentiment classification of the context window does not meet a predefined accuracy threshold.

20. The system of claim 11, wherein the text segment is a word, a phrase, or a sentence.
